(19) United States
(12) Patent Application Publication
(10) Pub. No.: US 2022/0383393 A1
(43) Pub. Date: Dec. 1, 2022

(54) SYSTEM AND METHOD FOR SELECTING AND PROCESSING TRANSACTIONS INVOLVING A PLURALITY OF STORES OFFERING SIMILAR ITEMS FOR SALE

(71) Applicant: Paul Krawitz, Cold Spring Harbor, NY (US)

(72) Inventor: Paul Krawitz, Cold Spring Harbor, NY (US)

(21) Appl. No.: 17/335,460

(22) Filed: Jun. 1, 2021

(51) Int. Cl. G06Q 30/06

(52) U.S. Cl. CPC G06Q 30/0635; G06Q 30/0609

(57) ABSTRACT

The system receives registration from at least one seller and at least one wholesaler. The seller or wholesaler can register via an Application (“App”) on its mobile deice or via a computer device to run a program. During the registration process, the system provides a code to each seller to identify the seller. The seller provides the code to potential customers. After accessing the system via an app or a website, the system receives the code from the customer. The system can be a platform and/or managed by a store server. The system receives an order selection from the customer. The system receives payment information from the customer, and the system debits the customer's account and credits the sellers account for the retail price of the purchase. The system sends the order information to the wholesaler; the wholesaler can fill the order. The system debits the seller's account and credits the wholesaler's account for the wholesale price of the purchase. The system can generate one or more reports for the seller and/or the wholesaler.

### BACKGROUND

The present application is directed to a system and method for selecting and processing transactions involving a plurality of stores offering similar items for sale.

A merchant may use an e-commerce platform to sell goods and/or services to customers. The number of merchants that use an e-commerce platform may be great in number. The merchants may also be geographically dispersed. The number of services or products provided by merchants is enormous.

Many merchants provide services and products for customers over the Internet. The daily management of an Internet-based store requires the presenting products, accepting orders, filling the orders, paying a wholesaler, etc. For example, doctors who belongs to a particular clinic may wish to recommend vitamins or dietary supplements to their patients, but do not want to be involved with the day-to-day management of an Internet-based store. Also, wholesalers might want to retain sellers for sales promotion. Nevertheless, securing a transaction between a seller and a customer is difficult under a fully-opened internet environment and further, customers and sellers may want to have exclusive transactions within their own platforms.

As one of the solutions, many third parties provide platforms where a seller and a customer can be connected. For example, Amazon® provides an intermediary transaction service with their own platform. These third party platforms are often expensive to use for sellers who receive only a small part of the sale price due to the third party retaining its commission. Even with these third-party platforms, a seller is still bogged down by the day-to-day management of the transactions. The intermediary transaction service might be a solution but the transaction must be in the third party's platform and the sales transaction between a seller and a customer is managed through the intermediary service company. All transactions including payment is managed, collected and operated under an intermediary company. There are fewer options for the seller to choose or connect to customers.

As another system, a third party's service may come with a charge or transaction fee between a customer and a merchant. The transaction fee can be extracted on each sale or transaction. Customers or sellers may not want to utilize the intermediary services. Besides, a seller might be unable to provide customized information for a customer because a transaction between customer and seller must occur within the third party's intermediary platform. Even if some merchants provide customized information regarding the service, it might be difficult for customers to find the right merchants because the platform is one of numerous platforms on the Internet.

The present disclosure solve these and other problems in the prior art.

### SUMMARY OF THE INVENTION

A wholesaler can retain sellers and generate a platform for each seller. Sellers who provide particular services or products are designated with a simple code. The stores can be hosted on a store server. The wholesaler's platform is searchable with the designated code. By entering the code, a seller is identified. A seller and a customer are directly connected through the store server and the app without any interruption by the third party. The code can be automatically generated or designated when the sellers or wholesalers register on the platform. The information represented by a code may be as simple as a string of numbers and/or letters and other characters that identify a merchant and/or a particular type of service of the merchant.

A computer-implemented method may include retrieving data specific to a particular store that has an e-commerce platform. The method may further include using the data to categorize the particular merchant as belonging to a particular category of a plurality of merchant categories, where each category of the plurality of wholesalers' categories has associated therewith a respective subset of groups. For example, the first group can be some type wholesaler and second group can be a seller belonging to one of the wholesalers. The method may further include selecting a target group that the particular merchant is not already associated with. The target group is selected from the subset of groups associated with the particular service category or products. The method may further include storing in database an association between the particular seller, where a seller can be a clinic or any other type of the professional such as doctor, and the target group in order to associate the particular wholesaler, where wholesaler can be vitamin, herbs, dietary company, with the target group. In some embodiment, the first group can be some type clinics and second group can be doctors belonging to one of the clinics. The method may further include selecting a target group that the particular merchant is not already associated with. The target group is selected from the subset of groups associated with the particular service category or service. The method may further include storing in database an association between the particular doctor and the target group in order to associate the particular clinic with the target group. A system configured to perform the method may also be provided. For example, the system may include a database to clinic information related to a plurality of wholesalers and doctors, and a processor to perform some or all of the steps above for the particular clinic searching with a code which is provided by a doctor.

The transactions including providing products such as vitamin or dietary supplements information and ordering products on the platform can be directly connected from the seller and the customer. The transactions occur on the customized platform by a store or a wholesaler once the customer and seller are connected in the platform. Anyone can access to the platform and purchase a product with or without a code. The transaction can be recorded in a database. In some embodiments, the transaction can be protected from outside access because each store is designated with a code and a transaction with the targeted merchants under the app and customers quickly access the store' platform and protects from other third party' interruption or confusion because there are no other public input or general searching term unless they install an app. The direct connection between a customer and a seller removes the intermediary fee.

As another embodiment, the customer and seller transaction information can be updated based on the access and service payment. The customer can purchase a product on the platform with the code identifying a seller. The order of product along with payment information can be directly transferred to the seller. The transaction with payment information such as banking or credit card information can be controlled by another entity. For example, a mobile or computer application may assist to the payment transaction including credit or debit card information between the customer and seller. Further, the mobile or computer application can assist to the payment information between a customer and a seller. Purchase options can include payment methods accepted by the platform provided seller or wholesaler. Payment methods can include, for example, credit cards, cashier's check, or cash. Once a wholesaler checks and verifies the order and payment information between a customer and seller at the platform, the product can be delivered or provided. Delivery options can be the delivery methods available to the customer from a wholesaler. Delivery methods can include, for example, paperless delivery, online delivery, will-call, or mail. Service charges can be additional fees associated with a purchase (e.g., shipping, handling or processing). Each sale between a customer and a seller can be recorded on a database. The payments of customers can be transferred from sellers to a wholesaler at a determined time. The remittance and transfer between a seller and wholesaler can be controlled and monitored by a separated entity. Further, each transfers of the payment from the customer to seller and seller to wholesaler can be managed or controlled by a third entity. The customer's credit card usage and sales report under each seller's code or name can be transferred to the wholesalers by weekly, monthly, or any set up time, by a store server. The wholesaler can provide a commission, incentive, or any type of reward to the seller based on the reported sale activities of each seller. If there is no service usage or payment record from each seller, a system can automatically removes the stores or seller for the protection after several warnings to the stores and the clinics because there might be a risk of any fraud or false information.

A system method for processing electronic transaction between a customer, a seller, and a wholesaler in a system through a wireless network comprises; the system receives a registration information from at least one seller and at least one wholesaler; the system provides a code to each seller and the seller provides the code to the customer; the system receives the code from the customer; the system can be a platform and/or managed by a store server; the system receives an order selection from the customer; the system receives payment information from the customer; the system debits the customer's account and credits the seller's account for the retail price of the purchase; the system sends an other information to the wholesaler and the wholesaler fills the order; the system debits the seller's account and credits the wholesaler's account for the wholesaler price of the purchase; and the system generates one or more reports for the seller and the wholesaler.

### BRIEF DESCRIPTION OF THE DRAWINGS

Various embodiments are described below with reference to the drawings wherein:

FIG. 1 is a flow chart of method for processing electronic transactions between a customer, a seller, and wholesaler according to the present application;

FIG. 2 is a diagram illustrating a system and network connecting devices according to the present application;

FIG. 3 is a diagram illustrating a seller and a wholesaler registering in the database with a code according to the present application;

FIG. 4 is a diagram illustrating system generating a code and imposing the code to a seller and a wholesaler according to the present application;

FIG. 5 is a diagram illustrating description of a clinic and doctor as the seller being grouped with a wholesaler according to the present application;

FIG. 6 is a diagram illustrating a clinic and doctors being registered in the system and customer access the app with a code to purchase an item according to the present application;

FIG. 7 is a diagram illustrating a store server checking and monitoring wholesalers and items on the platform according to the present application;

FIG. 8 is a diagram illustrating in the network a wholesaler and a seller's transaction process being managed by a store server according to the present application;

FIG. 9 is a diagram illustrating a customer choosing an item based on the clinic (or doctor)'s code and each item being listed up in the platform according to the present application;

FIG. 10 is a diagram illustrating the process of the choosing and ordering item from a customer in the platform according to the present application;

FIG. 11 is a diagram illustrating a transferring payment information between a customer and a clinic on the platform provided by the store server according to the present application;

FIG. 12 is a diagram illustrating a customer order information being recorded in the system and payment information is verified by the wholesaler according to the present application;

FIG. 13 is a diagram illustrating a reporting process of the payment information to the wholesaler from the seller according to the present application;

FIG. 14 is a diagram illustrating processes of product order with a payment information between a customer and a seller and a wholesaler according to the present application;

FIG. 15 is a diagram illustrating a customized screen for a customer and a wholesaler according to the present application; and

FIG. 16 is a diagram illustrating a payment entity for wholesaler between a customer and a wholesaler.

### DETAILED DESCRIPTION OF PREFERRED EMBODIMENT(S)

The present disclosure may be understood more readily by reference to the following detailed description of the disclosure taken in connection with the accompanying drawing figures, which form a part of this disclosure. It is to be understood that this disclosure is not limited to the specific devices, methods, conditions, or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure.

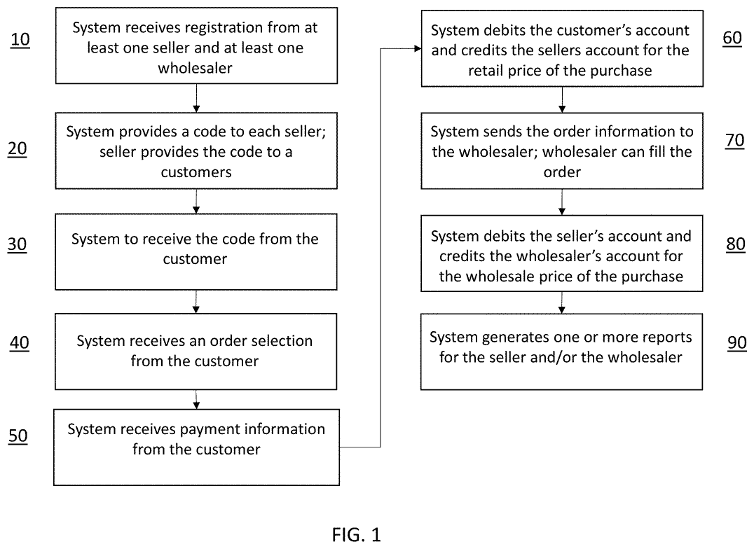

Referring to FIG. 1, illustrated is a flow chart for a method for processing electronic transactions between a customer, a seller, and wholesaler. At step 10 the system receives registration from at least one seller and at least one wholesaler. The seller or wholesaler can register via an Application (“App”) on its mobile deice or via a computer device to run a program. During the registration process, the system provides a code to each seller to identify the seller. The seller provides the code to potential customers. After accessing the system via an app or a website, at step 30 the system receives the code from the customer. The system can be a platform and/or managed by a store server. At step 40 the system receives an order selection from the customer. At step 50 the system receives payment information from the customer, and at step 60 the system debits the customer's account and credits the sellers account for the retail price of the purchase. At step 70 the system sends the order information to the wholesaler; the wholesaler can fill the order. At step 80 the system debits the seller's account and credits the wholesaler's account for the wholesale price of the purchase. At step 90 the system can generate one or more reports for the seller and/or the wholesaler.

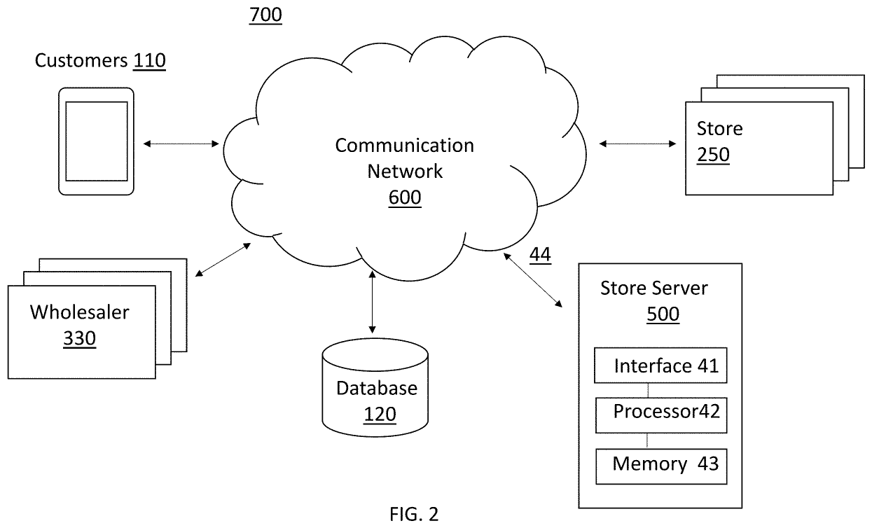

Referring to FIG. 2, illustrated is a system block diagram of a system for locating an item for purchase via a communication network and processing the transaction according to the present application. System 70 includes customer terminal 10, seller or store terminal 30, wholesaler terminal 40, store server 50, communication network 60, and database 20. Customer terminal 10, store server 50, seller terminal 30, wholesaler terminal 40, and database 10 are operatively coupled to communications network 60. In some embodiments, database 20 can be directly coupled to store server 50 or operatively coupled to store server 50 via a communications network separate from communications network 60 such as a local area network (“LAN”). Communications network 60 can be any communications network configurable to allow customer terminal 10, stores terminal 30, wholesaler's terminal 40, store server 50, and database 20 to communicate with communications network 60 and/or to each other through communications network 60. Communications network 60 can be any network or combination of networks capable of transmitting information (e.g., data and/or signals) and include, for example, a telephone network, an Ethernet network, a fiber-optic network, a wireless network, and/or a cellular network.

In some embodiments, communications network 60 can include multiple networks operatively coupled to one another by, for example, network bridges, routers, switches and/or gateways. For example, customer terminal 10 can be operatively coupled to a cellular network and store server 50 can be operatively coupled to a fiber-optic network. The cellular network and fiber-optic network can each be operatively coupled to one another via one or more network bridges, routers, switches, and/or gateways such that the cellular network, the Ethernet network and the fiber-optic network are operatively coupled to form a communications network. Alternatively, the cellular network and fiber-optic network can each be operatively coupled to one another via one or more additional networks. For example, the cellular network and the fiber-optic network can each be operatively coupled to the Internet such that the cellular network, the fiber-optic network and the Internet are operatively coupled to form a communications network.

In some embodiments, a network connection can be a wireless network connection such as, for example, a wireless fidelity (“Wi-Fi”) or wireless local area network (“WLAN”) connection, a wireless wide area network (“WWAN”) connection, and/or a cellular connection. In some embodiments, a network connection can be a cable connection such as, for example, an Ethernet connection, a digital subscription line (“DSL”) connection, a broadband coaxial connection, and/or a fiber-optic connection.

In some embodiments, a system can include more than one customer terminal, more than one store or seller terminal, more than one wholesaler terminal, and/or more than one database. Thus, for example, a store terminal can access multiple wholesaler terminals and a store server can direct more than one wholesaler's terminal to store servers. In some embodiments, a first store terminal, a second store terminal and/or a store server can be operatively coupled to a communications network by heterogeneous network connections. For example, a store terminal can be operatively coupled to the communications network by a WWAN network connection, another store terminal can be operatively coupled to the communications network by a DSL network connection, and a store server can be operatively coupled to the communications network by a fiber-optic network connection.

Store server 50 includes interface 41, processor 42 and memory 43. Store server 50 is operatively coupled to communications network 60 via interface 41 and network connection 44. Interface 41 can be any interface configurable to be operatively coupled to communications network 60 via network connection 44. For example, an interface can be a wireless interface such as, for example, a worldwide interoperability for microwave access (“WiMAX”) interface, a high-speed packet access (“HSPA”) interface, and/or a WLAN interface. An interface can also be, for example, an Ethernet interface, a broadband interface, a fiber-optic interface, and/or a telephony interface.

Processor 42 is operatively coupled to interface 41 such that processor 42 can be configured to be in communication with communications network 60 via interface 41. Processor 42 can be any of a variety of processors. Such processors can be implemented, for example, as hardware modules such as embedded microprocessors, microprocessors as part of a computer system, Application-Specific Integrated Circuits (“ASICs”), and Programmable Logic Devices (“PLDs”). Some such processors can have multiple instruction executing units or cores. Such processors can also be implemented as one or more software modules in programming languages as Java™, C++, C, assembly, a hardware description language, or any other suitable programming language. A processor according to some embodiments includes media and computer code (also can be referred to as code) specially designed and constructed for the specific purpose or purposes.

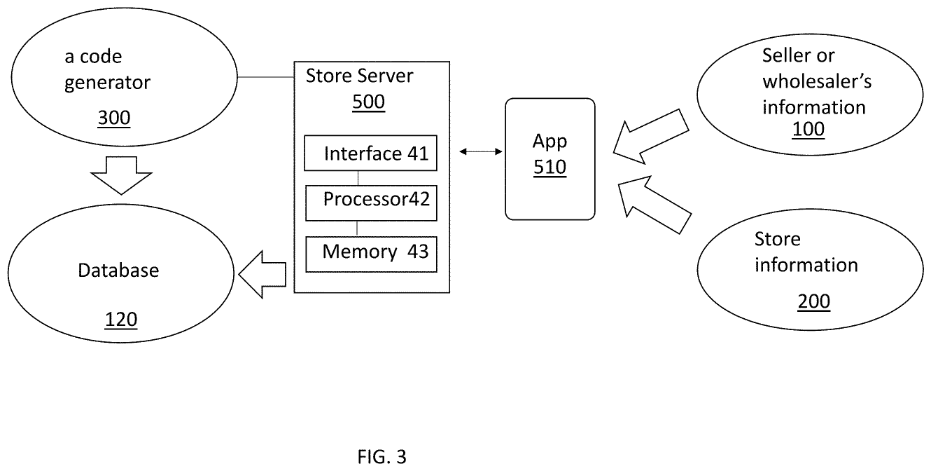

Referring to FIG. 3, an online platform providing store services is connected to the network. Here, the online platform of the store can include search engines, social media, creative content outlets, app stores, communication service, payment system, service, or product information, and so forth. The information can include various service types and products.

Application (“App”) 500 can be a mobile application or a computer program to run the software that functions on the mobile device or computing device. The app can be built by a third party, and each seller and wholesaler can install it onto their device. The third party can load a commercial advertisement on the app or request a payment to install the app to customers or stores. A seller registers in a store server 50 when the store installs an app 500 and inputs proper information such as the services or products the store provides. In some embodiments, the store servers 50 can automatically collect the store's or individual information by store's platform's data. A computer program or a mobile app 500 may be used to collect the seller (or wholesaler) information 100 and store's information 200. The collected store information can be specified by service types by the input of the customers or stores. A code generator 300 can designate a first random code for each store or individual. If there are the same types of service or products, the system can combine each store into one group with another code. The designated information with stores and store's service or products information is recorded in the database 400.

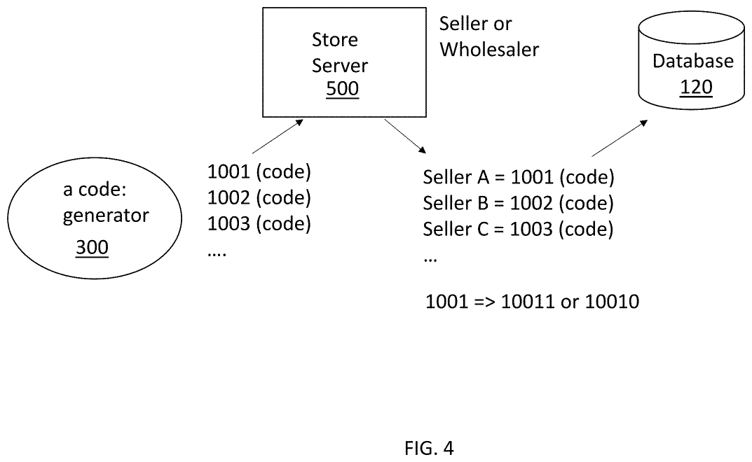

Referring to FIG. 4, a personal computer, a notebook or laptop computer, a mobile computing device (e.g., a smartphone, a personal digital assistant (“PDA”) or a tablet computing device), or some other computing device operated by the user can generate a random numbers to designate each store or code for the grouping. In some embodiments, the generator can impose a simple 4 digits code for each seller but the particular numbers are not limited to the digits when the seller or the wholesaler registers an app with the information with a service or product. For example, here, the codes, 1001, 1002, 1003, and so forth, are generated. The code is shared by the store server 500. Each store is imposed with a unique code to be identified. The process of selection and imposition are operated the process of the store server 500. The computer-generated code should be unique to each seller. The store server 500 checks and monitors every code when the code is created by the seller or the wholesaler. Each code may be connected to a symbolized words. For example, seller A is connected with a code, 1001. Seller A with particular products is designated with the code 1001. Seller B with another particular service is connected with a code, 1002. Seller B is designated with the code 1002, and so forth. The code numbers along with store's information such as services or products is recorded in the database 10.

The customer can see the list of products on the screen of the app after inserting a code, and therefore does not need to search for a particular service or product. In some embodiments, when a customer inputs the particular products on the app, the list of products can be shown on the screen of the app. If there are beyond the capacity of designated numbers of groups, the digit of numbers will be automatically expanded and the customers does not need to be notified with the updated information. For example, the code, 1001 will be expanded from 4-digit code to 5-digit code, 10011 or 100010, so the codes can contain newly created digits. The code generator or the store sever can check every newly created digit in order not to overlap with other codes.

Seller can be required to sign up and set up a code for a customer. Seller can be required to register a mobile or computer application to receive the code. The application can display items or stores list after a seller registration is complete. Each code will lead to a specified store's platform or disclose customized services to the customer after the customer selects a store.

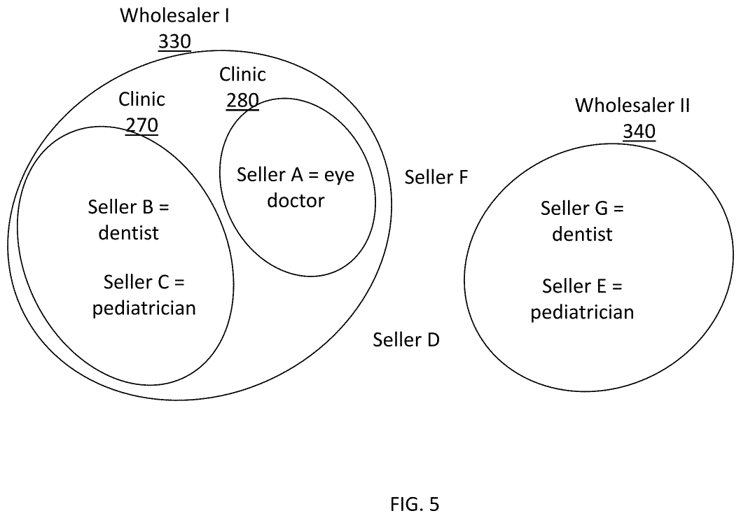

Referring to FIG. 5, sellers or wholesalers can be identified by a particular service or products. For example, a seller can be a clinic which has an eye doctor, a dentist, or a pediatrician. A wholesaler 10 and 20 can be vitamin, herbs, or dietary company. One or more embodiments of methods disclosed herein can directly link the sellers to online stores selling items. The process of selecting a seller or a store can be transparent to the customers. As an example, the customers can receive a service such as dental service or a medical treatment form a doctor and the doctor can provide a code for the customer to enter a clinic's store and be able to buy items such as vitamin, herb, or dietary supplements in the store. The store can be a wholesaler's store. The items can be extended to a ticket to a concert, a sporting event, an athletic event, a play, an opera, a ballet, and/or other tickets and be provided with a webpage at which the item can be purchased without additional action under the store's platform. Furthermore, items can include physical items such as books, consumer electronics, and/or other items.

As shown in FIG. 5, there are sellers from seller A to seller G providing different service or products. Each seller is designated with a different code. The store A to store C are grouped with Group I that is the wholesaler I and the store G and E are grouped with Group II that is the wholesaler II at 20 and each seller belonging to the same group shares the same products. Seller B and Seller C belong to a clinic 30 and seller A belong to a clinic 40. In some embodiments, the seller itself has a unique code different from the other clinics. The grouping will be decided by products in the platform.

In some embodiments, the products are not required to be the same type of products. For example, a customer wants to purchase a vitamin from a clinic 40 which has an eye doctor A and also need to purchase an herb from a clinic 30 which has a dentist B and a pediatrician C. The platform in the seller is customized with a clinic and doctors. The customer can make appointment and pay a product on the seller's platform. In some embodiments, the store can be individual doctor in the wholesaler 20. The doctors can be categorized with their profession and profiles. In this case, the group can be a wholesaler and the subgroup can be an individual doctor. Each doctor can be given particular selection code to be designated by the app and a group code can also be given to each doctor to be classified belonging to a wholesaler.

In some embodiments, the group code can be a clinic. The clinic itself has a unique code different from the other clinics. The grouping will be decided by the services and products in the platform. However, the service and the products are not required to be the same type of service. For example, a client wants to see a dentist doctor and also need to see an eye doctor and pediatrician in the same clinic. The group code in the clinic will impose the doctors as the same code. The platform in the clinic is customized with a dentist, an eye doctor, and pediatrician. The client can purchase an item and pay the item in the clinic's platform after check the doctors in the store. The doctors can be categorized with their profession and profiles. The doctors can belong to a clinic. In this case, the group can be a clinic and the subgroup can be an individual doctor.

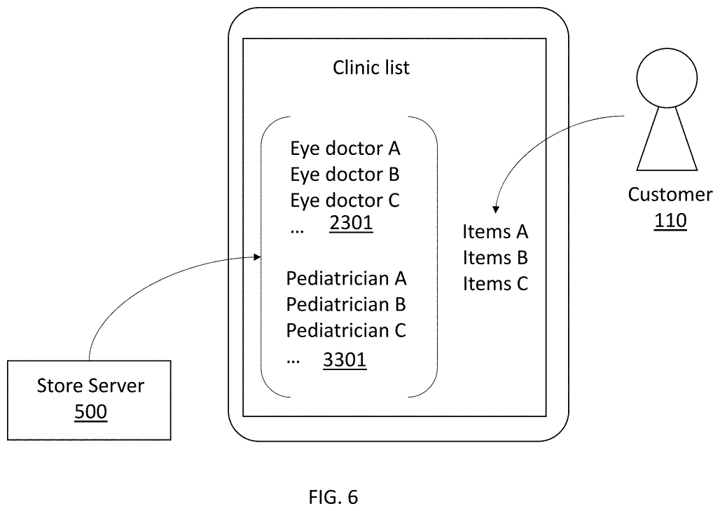

Referring to FIG. 6, a clinic and doctors is designated with a code. Dentists, eye doctors, and pediatricians can be separated by groups or clinic. Each group can comprise a group of relevant doctors. The customers can search for the store or clinic based on a product with the installed app. In some embodiment, the customer can search for the clinic with a code which is provided by a doctor. The customer does not need to remember all seller's name or product information. The code can impose more secured transactions between sellers and customers.

After a store as a group is identified or selected, the customer can be directly linked (or directed) to the identified doctors. For example, a customer seeks herbs supplements and insert the relevant words such as herbs. A browser at a customer terminal such as a personal computer, a notebook or laptop computer, a mobile computing device (e.g., a smartphone, a personal digital assistant (“PDA”) or a tablet computing device), or some other computing device operated by the customer can be redirected to a webpage of or associated with the seller identified code Sellers at 200 may be a clinic which has eye doctor A, B, and C, so customers can choose or select an item with a designated code which is provided by a doctor. In some embodiments, pediatricians of or associated with the seller identified at 300 can be linked inline or framed within a platform provided by a store server. The customer can select an item (or a representation such as a doctor) and be provided with a platform associated with an identified clinic without additional action (e.g., selecting a hyperlink at a webpage) by the customer. Thus, identifying the clinic and directly linking can be transparent to the customers such that the customer selects an item and is provided with the store's platform related to the clinic without identifying (or selecting) the doctor or selecting the store's webpage.

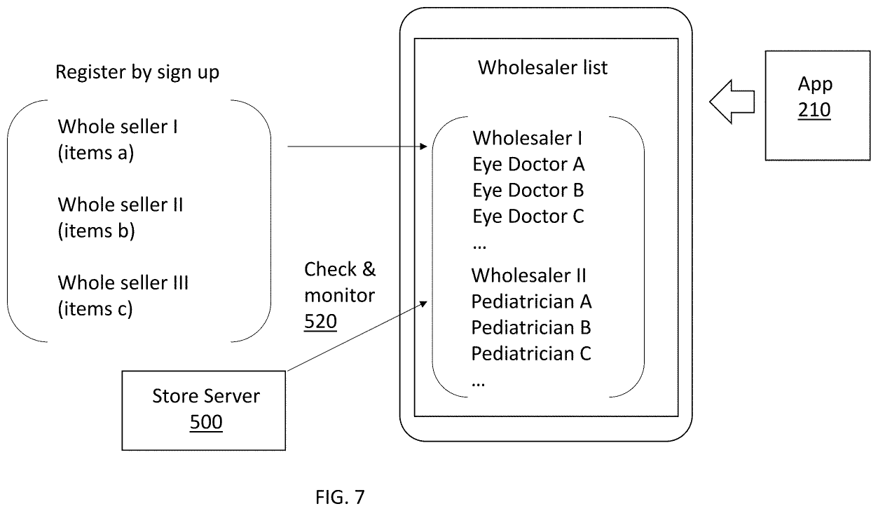

Referring to FIG. 7, a wholesaler can register an online service through a sign-up process. The store server 40 manages each store's platform and assigns the code. The code is generated by a code generator in the store sever otherwise, the code generator is connected to the network. When a wholesaler and a seller register or sign up, the store's information will be classified with a random code as described above with the creation of the code. Each clinic and doctors can be associated with a wholesaler after registration with its choice or a store server as designed by a computer program. An app service 20 can provide an app to a customer, so a wholesaler, a seller, and a customer can download and install the app to access to each other's information. The store server 40 checks and monitors the registered sellers and wholesalers in the database based on any usage of application or platform after installed at 50. The updated information can be checked once a week, a day, or a specified period depending on a system condition. To prevent fraud or false information, a customer can provide the review of the store or items. The app provider may check the stores or items whether they are in use by various methods such as the store's registration number to the state or the government.

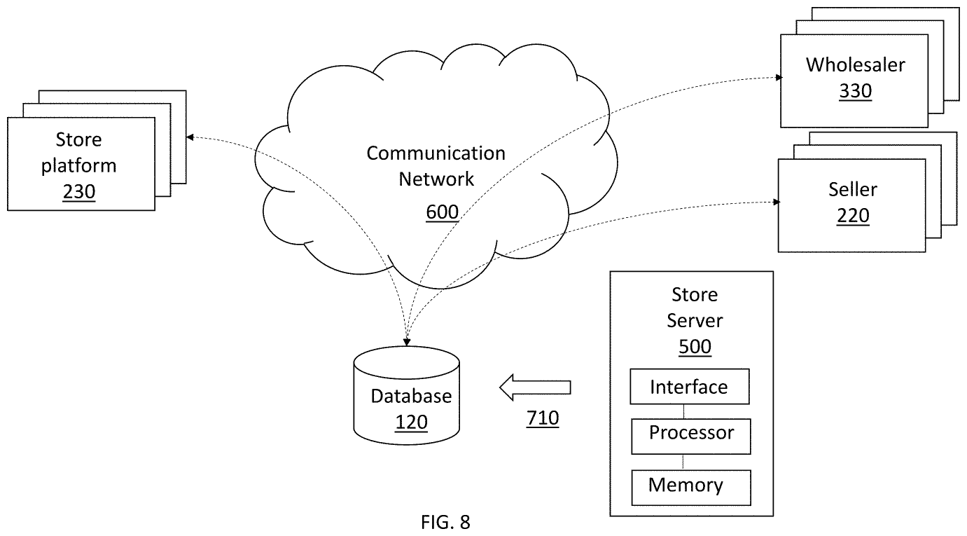

Referring to FIG. 8, each link with a store platform 20 and information along with customer information are recorded in Database 10. A store platform 20 can be a wholesaler's platform. Any updated information such as the store's profile or clinic and doctors' list along with its profile can be checked in database 10 and store sever 40 can commend or remove the information from the database at 70 through the interface of the store server 40. The third party can control or manage the store server 40. The updated information can be synchronized to customers and stores' app which is pre-installed. The synchronization can be instant when the relevant information is updated. For example, the new store or product is added to the list. The updated store or product information can be recorded in database 10 through communication network 50. Wholesaler's terminal 60 and seller's terminal 30 show the same information, which is updated through communication network 50. Likewise, the removal of the clinic and doctors or updated store's profile information such as new herbs or new vitamin will be recorded in the database 10 and the updated information will be shown instantly. The updated database can be transferred to a customer's mobile terminal and store's terminal. The updated information will be input by wholesaler 60, seller 30, or store sever 40. However, the main authority to remove and manage can be controlled by store server 40.

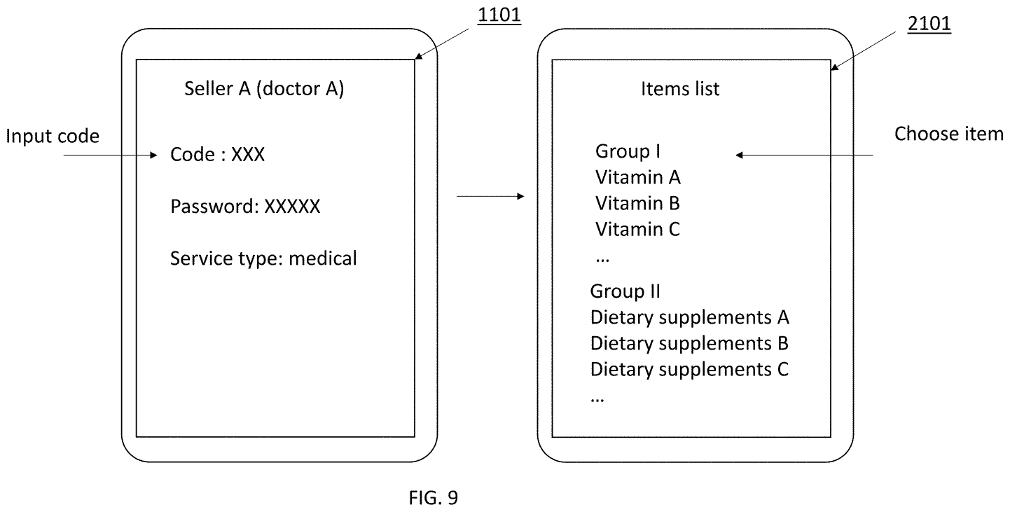

Referring to FIG. 9, the customer can download an app or install an app on a computer, mobile phone, or tablet. The app can be found on an app store, Google market, or any company's website page. After installed, the mobile or computer application screen 100 requires a customer to register with the specific information. The customer can set up the password and insert the customer's name. A registered customer will input the password to enter the app or a certain code identifying a seller. An installed app shows the list of products as well as services depending on the customer's input of the code. A customer can choose a product and a service which he or she wants to see among the list on the screen 200. The store and clinic list are in the database after each store and clinic are classified with a designated code. The list of stores and products are shown in the app screen 200 in the mobile or computer. The clinic and doctors might not be shown on the screen 200. The customer can choose a product or a service through the app with a code.

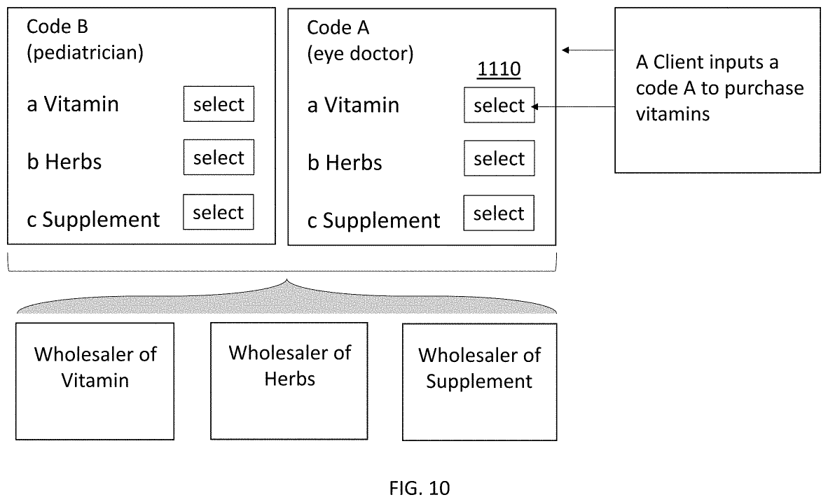

Referring to FIG. 10, a customer wants to purchase a vitamin his doctor recommended. The app can show the various health products such as vitamin, herbs, dietary supplement, and so forth. Various wholesalers can provide the health supplements and each doctor can sell the health supplements as a seller. Wholesalers can retain a clinic and doctors as a seller and the doctors can promote various health products for sale, which wholesalers designate. After a customer inputs a code A to purchase a vitamin, the product is sold by the clinic which has the eye doctor. When a customer touches or selects the button 100. The customer's purchase information is transferred to the clinic which has the eye doctor. In some embodiments, a customer can input the key code or password to find the clinic or store in the app using a mobile phone or computer. The doctor is registered and then receive the password or code. The doctor can provide the code to the customer to make a purchase. Once a customer chooses a clinic through a code, a clinic and a customer will be connected directly without any further third-party interruption. The doctor can provide the customized or exclusive service or information to the connected customer. When a customer accesses an application, the access leads directly to the wholesaler's website or screen page. The installed application can track the cookies placed on customer browser for proper order tracking. Once the app is installed on the customer's device, the history of connection between a customer and a clinic can be automatically recorded or saved on the store server. Accordingly, the customer can access the wholesaler's platform without logon or authenticate process. A wholesaler or a clinic can opt to block a customer if the customer provides the unsatisfied information such as bad credit score and a false credit information.

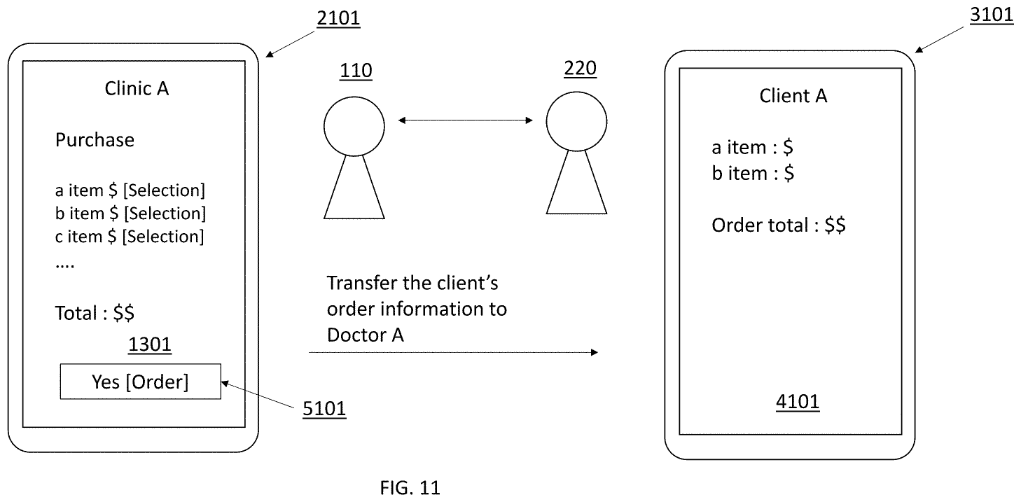

Referring to FIG. 11, after a customer and a seller are directly connected through the app, a customer 10 wants to purchase an item on the mobile or computer application screen 100. The screen 100 can be in the wholesaler's platform. The app platform 200 can be customized by the seller and the variable options and items or selection buttons can be exhibited for the customers. A seller 20 can provide health supplements or any other goods which can be related to the medical treatment and service but it is not limited. It can be any other tangible objects such as goods or products which a customer can purchase it through the app platform 100. The customer can put an order button 500 after selections. The total amount of the customer's purchase can be shown along with the selected items on the screen 100. The purchase order with the customer's information can be directly transferred to the seller. The seller can collect information through the app 300. The order information can be recorded in a database or a separated sever. The customer 10 can send its address information to receive the ordered product which was registered in the app. The customer can choose a delivery option or delivery address on the platform 200.

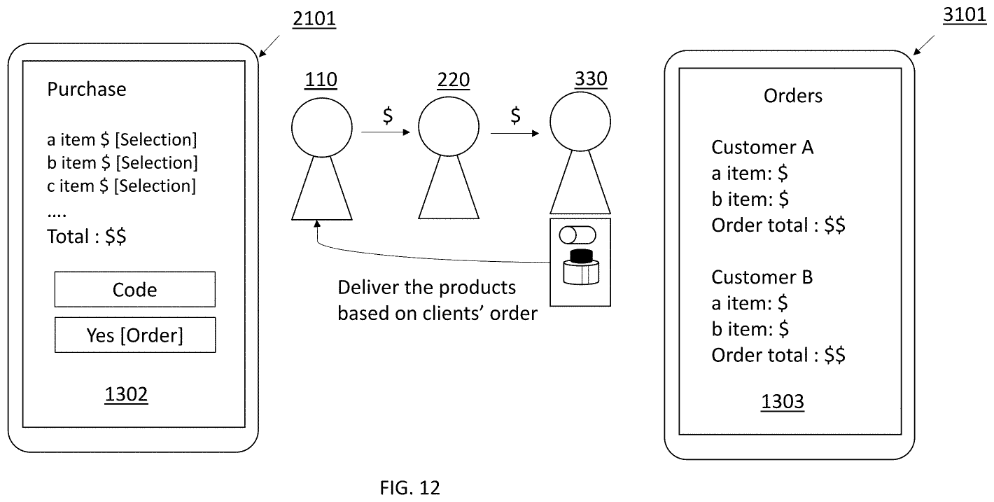

Referring to FIG. 12, a customer and a seller are directly connected with a code through communication network. A store will not be interrupted by a third party during a transaction occurring between a customer and a seller. A customer terminal screen 100 can show a store's information which is recorded in database. A store's terminal 300 connects to database through communication network. The customer's input information can be transferred to the database. The store server can access a database including products, availability, customer's order information, payment method, and/or other parameters to determine to which clinic to direct the user, so the customer order information is shown to the store's terminal 300. The screen 400 of the seller terminal 300 shows each customer's order details along with the payments. The customer order information can be recorded in the database. The store server can update or inform the order information to the wholesaler's terminal 300 through the network. A wholesaler can check the customer order information in the terminal screen 400. The wholesaler can deliver the products after a verification of the order information. The payment information can be recorded and monitored by the store server.

In some embodiments, the store server can query each store from the group of stores for pricing, availability, and/or other information related to charge to the customer in response to a message from a customer indicating which the service the customer has selected, and determine to which store to direct the customer based on this information. In other words, the store server can access parameters of or information related to the group of stores in real-time (e.g., the information is accessed at a computer server after the information has been requested). In some embodiments, the computer server can access information at a database and real-time information to determine to which store the user should be directed. The payments of customers 10 can be transferred from sellers 20 to a wholesaler at a determined time. The payments can be transferred weekly, monthly, or set up time by the wholesaler.

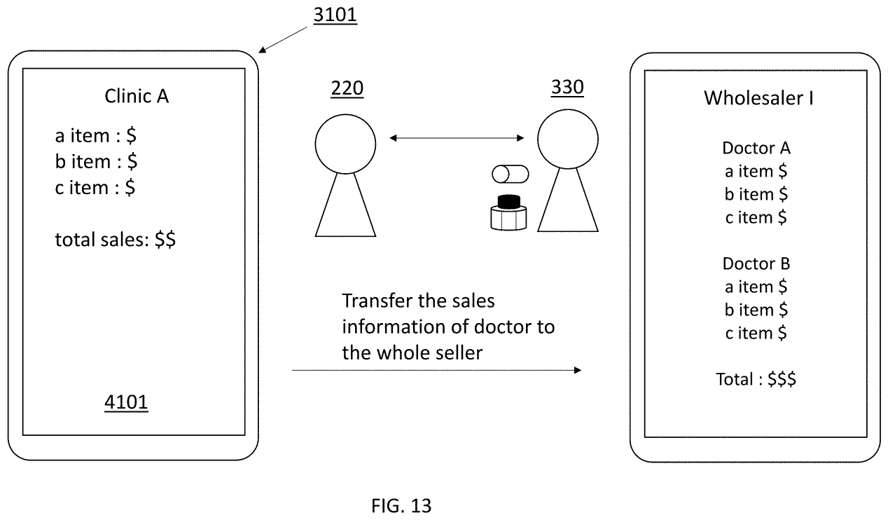

Referring to FIG. 13, the sales of the seller can be reported to the wholesalers 30. The wholesaler 30 can check each seller's sales weekly, weekly, or any set up time depending on the options. The seller can be a clinic at 20. The wholesaler can retain a clinic to sell the health supplements to customers. The wholesaler can provide an incentive, a commission, or any type of reward to the clinic based on the sales report. The clinic can also check its sales on the terminal screen 400. The sales information 300 can be each item sale along with the total sales which the clinic made. The wholesaler can receive the sales information of the clinic through a store server. In some embodiments, each clinic's sales can be detailed or categorized with the items. The wholesaler can provide more than one item for the transactions. The sales of each items may provide the detailed information to the wholesaler along with the clinic's sales.

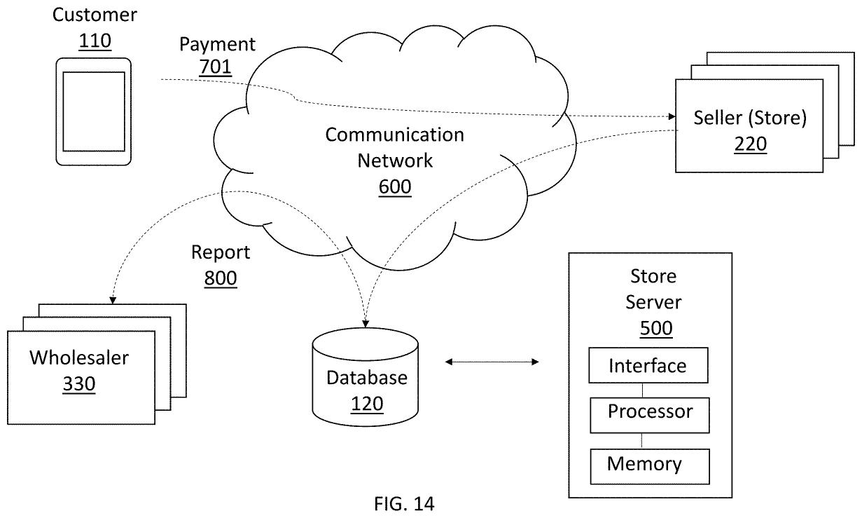

Referring to FIG. 14, the payment 70 from customer 20 is transferred to seller and the sales information can be recorded in the database 10. The payments from a customer to a seller can be transferred to a wholesaler at a determined time or set up time after transaction. The recorded sales information can be reported to the wholesaler 60. In some embodiments, the sales report information 80 can be separated from the customer's order information. The customer order information can be informed to wholesaler by a store server 40. The order information can be checked and verified by the wholesaler 60. The remittance and transfer can be controlled and monitored by a separated entity. Customer order information can be stored in a database 10 and monitored by the store server 40. In some embodiment, the system can debit the customer's account and credits the sellers account for the retail price of the purchase at the step of the payment 70. The system sends the order information to the wholesaler. The wholesaler 60 can fill the order. The system debits the seller's account and credits the wholesaler's account for the wholesale price of the purchase at the step of reporting information 80.

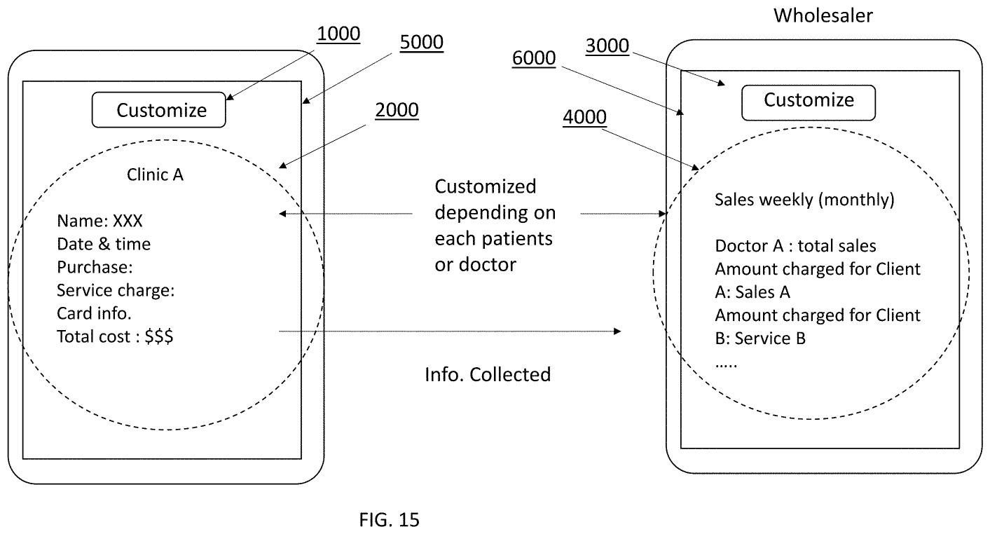

Referring to FIG. 15, the screen of application 500 shows specific information to make an order or to make a purchase with a code. The details of the input can be customized by a clinic or a wholesaler. A clinic or a wholesaler may use a merchant configurable domain name, a customizable HTML theme, and the like, to customize their online store 200. Merchants may customize the look and feel of their website through a theme system, such as where merchants can select and change the look and feel of their online store 200 by changing their theme while having the same underlying product and business data shown within the online store's product hierarchy. Themes may be further customized through a theme editor, a design interface that enables users to customize their platform website's design with flexibility. Themes may also be customized using theme-specific settings that change aspects, such as specific colors, fonts, and pre-built layout schemes. The online store may implement a content management system for website content. A wholesaler may upload images (e.g., for products), video, content, data, and the like to the e-commerce platform 200, such as for storage by the system. In some embodiments, the e-commerce platform 200 may provide functions for resizing images, associating an image with a product, adding and associating text with an image, adding an image for a new service or product variant, protecting images, and the like. The customer can be shown the necessary information to order a product and the information directly transferred to clinic or store, which the customer chose. The screen 600 for wholesaler can be customized with the button 300. A wholesaler can receive sales weekly, monthly, or any set up time, which can be customized or be optionally listed. The details of the customized screen 400 can comprise the amount charged for each customer and for each clinic. Also, the clinic can receive the report of the total sales information as well as each clinic's incomes or charges. When a customer chooses a product among the list, order of product and input its customer information will be created with a clinic's code. Further, cookies placed on customer browser for proper order tracking will be created. A custom fulfillment service may send an email (e.g., a location that doesn't provide an API connection). An API fulfillment service may trigger a wholesaler where the wholesaler application creates a fulfillment record.

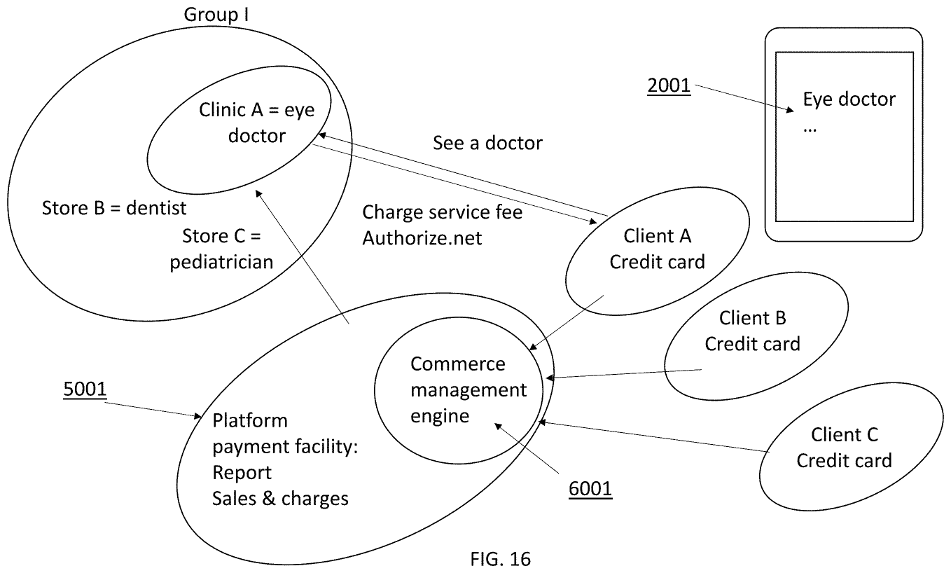

Referring to FIG. 16, in some embodiments, a third-party associate providing the sales report and charges of each customers with product to clinic A (eye doctor). Customers' credit card information and customers list can be provided by a request from a clinic through an installed application. The FIG. 14 shows that the customer information is collected and transferred to the clinic (a doctor) when the customer input the relevant information on the screen 200. When a separate entity can charge a service fee to the customer or store request the payment from the customer who used a service, another application can be associated such as authorize.net for this transaction. In some embodiments, the e-commerce platform 200 may provide for a platform payment facility 500, which is another example of a component that utilizes data from the commerce management engine 600 but may be located outside so as to not violate the isolation principle. The platform payment facility 500 may allow customers interacting with online stores to have their payment information stored safely by the commerce management engine 600 such that they only have to enter it once. When a customer visits a different online store, even if they've never been there before, the platform payment facility 500 may recall their information to enable a more rapid and correct check out. This may provide a cross-platform network effect, where the e-commerce platform becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 200. It would be difficult and error prone for each online store 200 to be able to connect to any other online store to retrieve the payment information stored there. As a result, the platform payment facility may be implemented external to the commerce management engine 600.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

Where this application has listed the steps of a method or procedure in a specific order, it may be possible, or even expedient in certain circumstances, to change the order in which some steps are performed, and it is intended that the particular steps of the method or procedure claim set forth herein below not be construed as being order-specific unless such order specificity is expressly stated in the claim.

While the preferred embodiments of the devices and methods have been described in reference to the environment in which they were developed, they are merely illustrative of the principles of the inventions. Modification or combinations of the above-described assemblies, other embodiments, configurations, and methods for carrying out the invention, and variations of aspects of the invention that are obvious to those of skill in the art are intended to be within the scope of the claims.

1. A method in an online store system for processing consumer transactions between a user, a seller in a clinic, and a wholesaler, comprising:
receiving at a processor registration information from at least one seller and at least one wholesaler;
generating, by a code generator, a selection code for the at least one seller and a group code for at least one clinic,
wherein the selection code identifies the at least one seller and products associated with the at least one seller and provides the user access to the online store system, and
wherein the group code identifies more than one seller in a specific clinic;
receiving, by the processor, the selection code entered by the user;
displaying to the user, by the processor, on a screen of a terminal device a list of products to place an order,
wherein the list of products are expanded by the group code, wherein the group code is associated with the selection code, and the list of products are defined by the group code and contain more than one seller's products;
receiving from the terminal device, by the processor, order information;
recording, by the processor, payment information in a database;
debiting, by the processor, a user account and crediting a seller account for a retail price of an electronic secured transaction associated with the order information;
debiting, by the processor, the seller account and crediting a wholesaler account for a wholesaler price of the electronic secured transaction; and
synchronizing, by the processor, a seller application and a wholesaler application to reflect the electronic secured transaction.

2. The method of claim 1, further comprising generating, by the processor, one or more reports detailing one or more transactions of the seller or the wholesaler.

3. (canceled)

4. The method of claim 1, wherein receiving the registration information comprises:
receiving, by the processor, the registration information via the wholesaler application or the seller application on a mobile device or a computer device;
saving, by the processor, the registration information in the database; and
adding, by the processor a store, the at least one wholesaler, or the at least one seller to the database.

5. The method of claim 1, wherein the electronic secured transaction is conducted on a system managed by the online store system.

6. (canceled)

7. The method of claim 1, wherein receiving the registration information further comprises receiving, by the processor, from the at least one wholesaler a list of products being sold by the at least one seller.

8. The method of claim 1, wherein the electronic secured transaction is managed by a third party.

9. The method of claim 2, wherein the report includes sales information on a weekly, monthly, or other preset time period.

10. The method of claim 1, further comprising:
Categorizing, by the processor, the at least one seller as belonging to a category of sellers selected for a plurality of categories, wherein each category has associated therewith a respective subset of sellers.

11. A system in an online store system for processing electronic transactions between a customer, seller in a clinic, and a wholesaler, comprising:
a processor configured to:
receive registration information from at least one seller or at least one wholesaler;
generate, by a code generator, a selection code for the at least one seller and a group code for at least one clinic,
wherein the selection code identifies the at least one seller and products associated with the at least one seller and provides the user access to the online store system, and
wherein the group code identifies more than one seller in a specific clinic;
receive, by the processor, the selection code entered by the user;
display to the user, by the processor, on a screen of a terminal device a list of products to place an order,
wherein the list of products are expanded by the group code, wherein the group code is associated with the selection code, and the list of products are defined by the group code and contain more than one seller's products;
receive from the terminal device, by the processor, an order information;
record, by the processor, payment information in a database;
debit, by the processor, a user account and crediting a seller account for a retail price of an electronic secured transaction associated with the order information;
debit, by the processor, the seller account and crediting a wholesaler account for a wholesaler price of the electronic secured transaction; and
synchronize, by the processor, a seller application and a wholesaler application to reflect the electronic secured transaction.

12. The system of claim 11, wherein the processor is further configured to generate a report detailing one or more transaction of the seller or the wholesaler.

13. (canceled)

14. The system of claim 11, wherein the processor is further configured to:
receive the registration information via the wholesaler application or the seller application on a mobile device or a computer device;
save the registration information in the database; and
add a store, the at least one wholesaler, or the at least one seller to the database.

15. The system of claim 11, wherein the electronic secured transaction is managed by the online store system.

16. (canceled)

17. The system of claim 11, wherein the processor is further configured to receive from the at least one wholesaler a list of products being sold by the at least one seller.

18. The system of claim 11, wherein the electronic secured transaction is managed by a third party included in the online store system.

19. The system of claim 12, wherein the report includes sales information on a weekly, monthly, or other preset time period.

20. The system of claim 11, wherein the processor is further configured to categorize the at least one seller as belonging to a category of sellers selected for a plurality of categories, wherein each category has associated therewith a respective subset of sellers.
